(19) United States
(12) Patent Application Publication
(10) Pub. No.: US 2025/0289943 A1
(43) Pub. Date: Sep. 18, 2025

(54) RUBBER COMPOSITION AND VIBRATION-PROOF RUBBER

(71) Applicants: SUBARU CORPORATION, Tokyo (JP); SUBARU TECNICA INTERNATIONAL INC., Tokyo (JP); FUJIGOMU INDUSTRY CO., LTD., Gunma (JP)

(72) Inventors: Hiroaki KURODA, Tokyo (JP); Makoto KATAOKA, Tokyo (JP); Masanori YAGISAWA, Gunma (JP)

(73) Assignees: SUBARU CORPORATION, Tokyo (JP); SUBARU TECNICA INTERNATIONAL INC., Tokyo (JP); FUJIGOMU INDUSTRY CO., LTD., Gunma (JP)

(21) Appl. No.: 19/003,885

(22) Filed: Dec. 27, 2024

(30) Foreign Application Priority Data
Mar. 14, 2024 (JP) 2024-040562

(51) Int. Cl. C08L 7/00; C08K 3/04; C08K 5/14

(52) U.S. Cl. CPC C08L 7/00; C08K 3/04; C08K 5/14; C08K 2201/006; C08K 2201/014; C08L 2205/22

(57) ABSTRACT

A rubber composition includes: a millable urethane polymer; an organic peroxide crosslinking agent; and carbon having a nitrogen surface area of 30 m²/g or more and 100 m²/g or less. The millable urethane polymer has a Mooney viscosity ML(1+4)100° C. of 29 or more and 90 or less. A content ratio of the organic peroxide crosslinking agent is 2 parts by mass or more and 4 parts by mass or less with respect to 100 parts by mass of the millable urethane polymer. A content ratio of the carbon is 1 part by mass or more and 40 parts by mass or less with respect to 100 parts by mass of the millable urethane polymer.

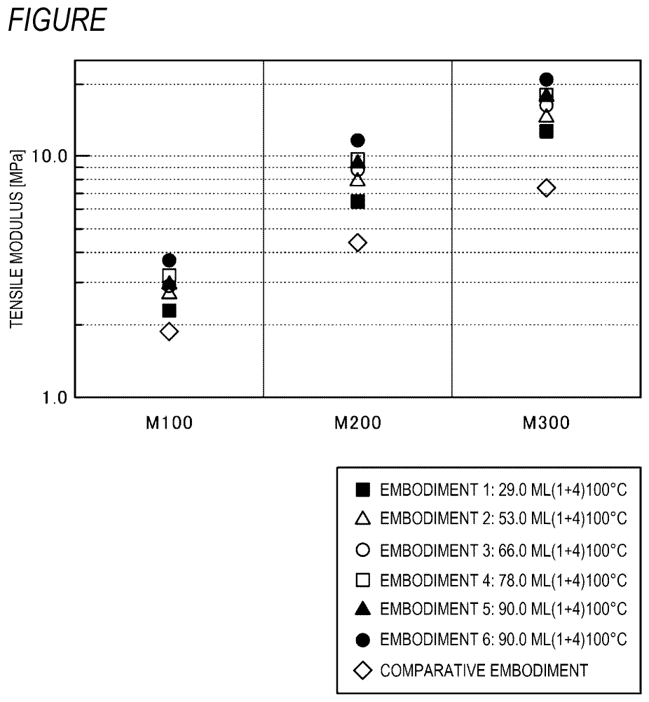

### CROSS-REFERENCE TO RELATED APPLICATIONS

The present application claims priority from Japanese Patent Application No. 2024-040562 filed on Mar. 14, 2024, the entire contents of which are hereby incorporated by reference.

### BACKGROUND

The present disclosure relates to a rubber composition and a vibration-proof rubber.

Vehicles are provided with a suspension system that connects a vehicle body and wheels in order to press the wheels against the road surface to keep the wheels in contact with the road, and to reduce transmission of vibration from the wheels to the vehicle body during driving. Among components constituting the suspension system, suspension bushings are required to have a vibration absorbing function for absorbing vibration.

In related art, natural rubber materials have been widely used for suspension bushings because they are low cost, easy to mold, and readily available. A natural rubber itself does not have enough hardness to support a vehicle body, so that the natural rubber cannot be used as it is for suspension bushings.

Therefore, a natural rubber material obtained by adding carbon as a reinforcing material to a natural rubber is used as a vibration-proof rubber for suspension bushings (for example, Japanese Unexamined Patent Application Publication No. 2023-96769A).

### SUMMARY

An aspect of the present disclosure provides a rubber composition including: a millable urethane polymer; an organic peroxide crosslinking agent; and carbon having a nitrogen surface area of 30 m²/g or more and 100 m²/g or less. The millable urethane polymer has a Mooney viscosity ML(1+4)100° C. of 29 or more and 90 or less. A content ratio of the organic peroxide crosslinking agent is 2 parts by mass or more and 4 parts by mass or less with respect to 100 parts by mass of the millable urethane polymer. A content ratio of the carbon is 1 part by mass or more and 40 parts by mass or less with respect to 100 parts by mass of the millable urethane polymer.

### BRIEF DESCRIPTION OF DRAWINGS

The accompanying drawings are included to provide a further understanding of the disclosure and are incorporated in and constitute a part of this specification. The drawings illustrate an embodiments and, together with the specification, serve to describe the principles of the disclosure.

The FIGURE is a graph showing a measurement result of a tensile modulus [MPa] in Embodiments 1 to 6 and Comparative Embodiment.

### DETAILED DESCRIPTION

Carbon inhibits extension and contraction of a natural rubber and a synthetic rubber. Therefore, a tensile modulus of the natural rubber and the synthetic rubber decreases as a content ratio of the carbon increases.

Therefore, in order to improve riding comfort, it is conceivable to reduce a content of carbon in a rubber for suspension bushings. However, when the content of carbon is too low, stability may worsen due to delays in starting to move when turning and increased vehicle body movement, resulting in a decrease in not only riding comfort but also steering stability.

Therefore, it is desired to develop a rubber composition that can achieve both improved riding comfort and improved steering stability.

In view of such a problem, an object of the present disclosure is to provide a rubber composition and a vibration-proof rubber that can achieve both improved riding comfort and improved steering stability by improving a tensile modulus.

Hereinafter, embodiments of the present disclosure are described in detail with reference to the accompanying drawings. The specific dimensions, materials, numerical values, and the like shown in the embodiments are merely embodiments for facilitating the understanding of the disclosure, and do not limit the disclosure unless otherwise specified. In the specification and the drawings, elements having substantially the same functions and configurations are denoted by the same reference signs, and a repeated description thereof is omitted, and elements having no direct relationship with the present disclosure are omitted.

### [Rubber Composition]

The rubber composition according to the present embodiment contains a millable urethane polymer, an organic peroxide crosslinking agent, and carbon.

### <Millable Urethane Polymer>

The millable urethane polymer is also called a millable urethane rubber. The millable urethane polymer is a polymer having a urethane bond in the molecule. As the millable urethane polymer, for example, various millable type urethane polymers can be used which have properties before curing similar to those of a normal uncrosslinked rubber and can be plasticized and kneaded in a roll mill or kneader or extrusion molded.

The millable urethane polymer is synthesized, for example, by reacting a polyol component, an isocyanate component, and, if necessary, a chain transfer agent. Examples of the polyol component include polyester, polyether, polycarbonate, and polyolefin.

The Mooney viscosity ML(1+4)100° C. of the millable urethane polymer according to the present embodiment is 29 or more and 90 or less, preferably 53 or more and 78 or less, more preferably 61 or more and 71 or less, and still more preferably 66.

The Mooney viscosity ML(1+4)100° C. is defined in JIS K6300-1: 2013. The Mooney viscosity ML(1+4)100° C. is a Mooney viscosity when a preheating time is 1 minute and a rotor rotation time is 4 minutes under measurement conditions of a test temperature of 100° C. and an L-shaped rotor.

As the millable urethane polymer according to the present embodiment, for example, either one or both of “E8010” which is a product name and manufactured by Eikos and “Iron Rubber” which is a product name and manufactured by NOK Corporation can be used.

### <Organic Peroxide Crosslinking Agent>

The organic peroxide crosslinking agent is, for example, bis(1-methyl-1-phenylethyl) peroxide.

A content ratio of the organic peroxide crosslinking agent in the rubber composition is 2 parts by mass or more and 4 parts by mass or less, preferably 2.5 parts by mass or more and 3.5 parts by mass or less, more preferably 2.6 parts by mass or more and 3.2 parts by mass or less, and still more preferably 2.8 parts by mass, with respect to 100 parts by mass of the millable urethane polymer.

### <Carbon>

The carbon is, for example, carbon black. A nitrogen surface area of the carbon according to the present embodiment is 30 m²/g or more and 100 m²/g or less. Here, the nitrogen surface area is a representative value obtained by a multipoint method.

In the present embodiment, the carbon may contain first carbon and second carbon, the nitrogen surface area of the second carbon being different from that of the first carbon. The carbon may consist only of the first carbon and the second carbon.

The nitrogen surface area of the first carbon is, for example, 30 m²/g or more and 50 m²/g or less. The nitrogen surface area of the second carbon is, for example, 70 m²/g or more and 90 m²/g or less.

Content ratios of the first carbon and the second carbon in the carbon contained in the rubber composition may be equal to or different from each other. The content ratio of the first carbon in the carbon contained in the rubber composition may be, for example, larger than the content ratio of the second carbon.

The content ratio of the carbon in the rubber composition is 1 part by mass or more and 40 parts by mass or less, preferably 20 parts by mass or more and 40 parts by mass or less, more preferably 30 parts by mass or more and 38 parts by mass or less, and still more preferably 34 parts by mass, with respect to 100 parts by mass of the millable urethane polymer.

### <Others>

The rubber composition may contain other additives as necessary in addition to the millable urethane polymer, the organic peroxide crosslinking agent, and the carbon. Examples of the additive include a plasticizer, a hydrolysis prevention agent, an antioxidant, a chemical dispersant, a lubricant, and an accelerator.

### [Effects of Rubber Composition]

Effects of the rubber composition according to the embodiment of the present disclosure are described.

In natural rubber materials of related art, hardness can be improved by increasing a content ratio of carbon. On the other hand, as the content ratio of carbon increases, a tensile modulus of the natural rubber material decreases. That is, the content ratio of carbon and the tensile modulus are in a trade-off relationship. Therefore, the natural rubber material of related art cannot achieve both improved hardness and improved tensile modulus.

Therefore, the rubber composition of the present embodiment contains a millable urethane polymer, an organic peroxide crosslinking agent, and carbon having a nitrogen surface area of 30 m²/g or more and 100 m²/g or less, the millable urethane polymer has a Mooney viscosity ML(1+4)100° C. of 29 or more and 90 or less, a content ratio of the organic peroxide crosslinking agent is 2 parts by mass or more and 4 parts by mass or less with respect to 100 parts by mass of the millable urethane polymer, and a content ratio of the carbon is 1 part by mass or more and 40 parts by mass or less with respect to 100 parts by mass of the millable urethane polymer.

As described above, the rubber composition according to the present embodiment contains a millable urethane polymer having a Mooney viscosity ML(1+4)100° C. of 29 or more and 90 or less and carbon, and a content ratio of the carbon is 1 part by mass or more and 40 parts by mass or less with respect to 100 parts by mass of the millable urethane polymer. Accordingly, the rubber obtained by crosslinking the rubber composition according to the present embodiment can have an improved tensile modulus. The tensile modulus is defined in JIS K6251:2017.

The rubber composition according to the present embodiment contains a millable urethane polymer having a Mooney viscosity ML(1+4) 100° C. of 29 or more and 90 or less and an organic peroxide crosslinking agent, and a content ratio of the organic peroxide crosslinking agent is 2 parts by mass or more and 4 parts by mass or less with respect to 100 parts by mass of the millable urethane polymer. Accordingly, the millable urethane polymer can be satisfactorily crosslinked, and hardness of the rubber obtained by crosslinking the rubber composition according to the present embodiment can be improved.

Therefore, using the rubber composition according to the present embodiment, both improved tensile modulus and improved hardness of the rubber after crosslinking can be achieved.

The Mooney viscosity ML(1+4)100° C. of the millable urethane polymer contained in the rubber composition according to the present embodiment may be 53 or more and 78 or less. Accordingly, the tensile modulus [MPa] can be further improved.

The carbon contained in the rubber composition according to the present embodiment may include first carbon and second carbon, the nitrogen surface area of the second carbon being different from that of the first carbon. Accordingly, wear of the rubber composition can be reduced.

The nitrogen surface area of the first carbon contained in the rubber composition according to the present embodiment may be 30 m²/g or more and 50 m²/g or less, and the nitrogen surface area of the second carbon may be 70 m²/g or more and 90 m²/g or less. Accordingly, the wear of the rubber composition can be further reduced.

The rubber obtained by crosslinking the rubber composition according to the present embodiment can be applied to a vibration-proof rubber. For example, the rubber composition according to the present embodiment may be applied to a vibration-proof rubber for a suspension bushing. The tensile modulus contributes to improvement of riding comfort and steering stability of the vehicle. Therefore, by applying the rubber composition according to the present embodiment to the vibration-proof rubber for a suspension bushing, both improved riding comfort and improved steering stability can be achieved, whether the vehicle is traveling in a straight line or on a curve.

An article to which the vibration-proof rubber is applied is not limited to the above-described suspension bushing. For example, the vibration-proof rubber according to the present embodiment can be applied to various articles such as muffler hangers used in automobile vehicles.

### Embodiment

Embodiments and Comparative Embodiment of the present disclosure are specifically described below. The following Embodiments are merely embodiments, and the rubber composition according to the present disclosure is not limited to the following Embodiments.

Rubber compositions in Embodiments 1 to 6 were prepared. The compositions in Embodiments 1 to 6 are shown in Table 1 below.

TABLE 1

| | | Embodiment 1 | Embodiment 2 | Embodiment 3 | Embodiment 4 | Embodiment 5 | Embodiment 6 |
|---|---|---|---|---|---|---|---|
| Type | Material | Parts by mass | | | | | |
| Polymer | E8010: 66.0 | — | 50 | 100 | 50 | — | — |
| | ML(1 + 4)100° C. | | | | | | |
| | E8010: 90.0 | — | — | — | 50 | 100 | 100 |
| | ML(1 + 4)100° C. | | | | | | |
| | E8010: 40.0 | — | 50 | — | — | — | — |
| | ML(1 + 4)100° C. | | | | | | |
| | Iron rubber: 29.0 | 100 | — | — | — | — | — |
| | ML(1 + 4)100° C. | | | | | | |
| Carbon | First carbon | 18 | 18 | 18 | 18 | 18 | 18 |
| | Second carbon | 16 | 16 | 16 | 16 | 16 | 16 |

| | | | | | | |
|---|---|---|---|---|---|---|
| Organic peroxide | 2.8 | 2.8 | 2.8 | 2.8 | 2.8 | 4.2 |
| crosslinking agent | | | | | | |

As shown in Table 1, in Embodiments 1 to 6, the content ratio of the first carbon in the rubber composition was 18 parts by mass with respect to 100 parts by mass of the millable urethane polymer. In Embodiments 1 to 6, the content ratio of the second carbon in the rubber composition was 16 parts by mass with respect to 100 parts by mass of the millable urethane polymer.

As shown in Table 1, in Embodiments 1 to 5, the content ratio of the organic peroxide crosslinking agent in the rubber composition was 2.8 parts by mass with respect to 100 parts by mass of the millable urethane polymer. In Embodiment 6, the content ratio of the organic peroxide crosslinking agent in the rubber composition was 4.2 parts by mass with respect to 100 parts by mass of the millable urethane polymer.

In Embodiments 1 to 6, additives such as a plasticizer, a hydrolysis prevention agent, an antioxidant, a chemical dispersant, a lubricant, and an accelerator were appropriately added.

### Embodiment 1

In Embodiment 1, as 100 parts by mass of the polymer, a millable urethane polymer manufactured by NOK Corporation under a product name “Iron Rubber” and having a Mooney viscosity ML(1+4) 100° C. of 29.0 was used.

### Embodiment 2

In Embodiment 2, a millable urethane polymer manufactured by Eikos under a product name “E8010” and having a Mooney viscosity ML(1+4)100° C. of 66.0 as 50 parts by mass of the polymer, and a millable urethane polymer manufactured by Eikos under a product name “E8010” and having a Mooney viscosity ML(1+4)100° C. of 40.0 as 50 parts by mass of the polymer were used.

### Embodiment 3

In Embodiment 3, as 100 parts by mass of the polymer, a millable urethane polymer manufactured by Eikos under a product name “E8010” and having a Mooney viscosity ML(1+4)100° C. of 66.0 was used.

### Embodiment 4

In Embodiment 4, a millable urethane polymer manufactured by Eikos under a product name “E8010” and having a Mooney viscosity ML(1+4)100° C. of 66.0 as 50 parts by mass of the polymer, and a millable urethane polymer manufactured by Eikos under a product name “E8010” and having a Mooney viscosity ML(1+4)100° C. of 90.0 as 50 parts by mass of the polymer were used.

### Embodiment 5

In Embodiment 5, as 100 parts by mass of the polymer, a millable urethane polymer manufactured by Eikos under a product name “E8010” and having a Mooney viscosity ML(1+4)100° C. of 90.0 was used.

### Embodiment 6

In Embodiment 6, as in Embodiment 5, as 100 parts by mass of the polymer, a millable urethane polymer manufactured by Eikos under a product name “E8010” and having a Mooney viscosity ML(1+4)100° C. of 90.0 was used.

### [Measurement of Mooney Viscosity ML(1+4)100° C.]

The Mooney viscosity ML(1+4) 100° C. of the millable urethane polymers in Embodiments 1 to 6 was measured. In the measurement of the Mooney viscosity ML(1+4)100° C., a Mooney viscosity ML(1+4)100° C. when a preheating time was 1 minute and a rotor rotation time was 4 minutes was measured under measurement conditions of a test temperature of 100° C. and an L-shaped rotor. The Mooney viscosity ML(1+4)100° C. in Embodiments 1 to 6 is shown in Table 2 below.

TABLE 2

| | | | | | | | | Comparative |
|---|---|---|---|---|---|---|---|---|
| | | Embodiment 1 | Embodiment 2 | Embodiment 3 | Embodiment 4 | Embodiment 5 | Embodiment 6 | Embodiment |
| Mooney viscosity | | 29.0 | 53.0 | 66.0 | 78.0 | 90.0 | 90.0 | — |
| ML(1 + 4)100° C. | | | | | | | | |
| Tensile | M100 | 2.3 | 2.7 | 2.9 | 3.2 | 3.0 | 3.7 | 1.9 |
| modulus | M200 | 6.5 | 8.0 | 8.8 | 9.7 | 9.4 | 11.7 | 4.4 |
| [MPa] | M300 | 12.7 | 14.7 | 16.2 | 17.9 | 17.7 | 20.8 | 7.5 |

| | | | | | | | |
|---|---|---|---|---|---|---|---|
| Hardness (HA) | 61.0 | 64.0 | 66.0 | 68.0 | 67.0 | 67.0 | 65.0 |

As shown in Table 2, the Mooney viscosity ML(1+4)100° C. in Embodiment 1 was 29.0. The Mooney viscosity ML(1+4)100° C. in Embodiment 2 was 53.0. The Mooney viscosity ML(1+4)100° C. in Embodiment 3 was 66.0. The Mooney viscosity ML(1+4)100° C. in Embodiment 4 was 78.0. The Mooney viscosity ML(1+4)100° C. in Embodiment 5 was 90.0. The Mooney viscosity ML(1+4)100° C. in Embodiment 6 was 90.0.

### [Measurement of Tensile Modulus]

The tensile modulus [MPa] of the rubbers each obtained by crosslinking the rubber compositions in Embodiments 1 to 6 and in Comparative Embodiment was measured. A commercially available blend of natural rubber (NR) and butadiene rubber (BR) was used as Comparative Embodiment.

M100, M200, and M300 in Embodiments 1 to 6 and Comparative Embodiment were measured, separately. For M100, the tensile modulus [MPa] is a tensile force [MPa] when a test piece is pulled until it reaches 100% elongation. For M200, the tensile modulus [MPa] is a tensile force [MPa] when a test piece is pulled until it reaches 200% elongation. For M300, the tensile modulus [MPa] is a tensile force [MPa] when a test piece is pulled until it reaches 300% elongation. The tensile force was measured using a “Tensilon universal material testing machine (product number: RT1-1310)” which was a product name and manufactured by A&D Company, Limited.

The tensile modulus [MPa] in Embodiments 1 to 6 and Comparative Embodiment is shown in Table 2 above. The FIGURE is a graph showing a measurement result of the tensile modulus [MPa] in Embodiments 1 to 6 and Comparative Embodiment. In the FIGURE, a black square represents Embodiment 1, a white triangle represents Embodiment 2, a white circle represents Embodiment 3, a white square represents Embodiment 4, a black triangle represents Embodiment 5, a black circle represents Embodiment 6, and a white rhombus represents Comparative Embodiment.

As shown in Table 2 and the FIGURE, the tensile modulus of M100 in Embodiment 1 was 2.3 [MPa]. The tensile modulus of M200 in Embodiment 1 was 6.5 [MPa]. The tensile modulus of M300 in Embodiment 1 was 12.7 [MPa].

The tensile modulus of M100 in Embodiment 2 was 2.7 [MPa]. The tensile modulus of M200 in Embodiment 2 was 8.0 [MPa]. The tensile modulus of M300 in Embodiment 2 was 14.7 [MPa].

The tensile modulus of M100 in Embodiment 3 was 2.9 [MPa]. The tensile modulus of M200 in Embodiment 3 was 8.8 [MPa]. The tensile modulus of M300 in Embodiment 3 was 16.2 [MPa].

The tensile modulus of M100 in Embodiment 4 was 3.2 [MPa]. The tensile modulus of M200 in Embodiment 4 was 9.7 [MPa]. The tensile modulus of M300 in Embodiment 4 was 17.9 [MPa].

The tensile modulus of M100 in Embodiment 5 was 3.0 [MPa]. The tensile modulus of M200 in Embodiment 5 was 9.4 [MPa]. The tensile modulus of M300 in Embodiment 5 was 17.7 [MPa].

From the results in Embodiments 1 to 4 described above, it was confirmed that by increasing the Mooney viscosity ML(1+4)100° C., the tensile modulus of M100, M200, and M300 was improved without increasing the content ratio of the carbon as a reinforcing material.

On the other hand, in Embodiment 5, it was confirmed that the tensile modulus of M100, M200, and M300 was lower than that in Embodiment 4 even though the Mooney viscosity ML(1+4)100° C. was as large as 90. In Embodiment 6, it was confirmed that the Mooney viscosity ML(1+4) 100° C. was 90, which was the same as that in Embodiment 5, but the tensile modulus of M100, M200, and M300 was improved compared to that in Embodiment 5. In Embodiment 6, it was confirmed that the tensile modulus of M100, M200, and M300 was improved compared to that in Embodiment 4.

The only difference between Embodiment 5 and Embodiment 6 is the amount of the organic peroxide crosslinking agent. A polymer having a long molecular chain has an increased number of crosslinking points as compared with a polymer having a short molecular chain. Therefore, in a polymer having a long molecular chain and a high Mooney viscosity ML(1+4)100° C. of 90, the organic peroxide crosslinking agent is required in an amount commensurate with the number of crosslinking points. Therefore, from the difference in tensile modulus between Embodiment 5 and Embodiment 6, it was confirmed that the tensile modulus of M100, M200, and M300 was improved by increasing a content ratio of the organic peroxide crosslinking agent when the Mooney viscosity ML(1+4)100° C. was 90.

On the other hand, it was confirmed that in Comparative Embodiment, the tensile modulus of M100, M200, and M300 was lower than that in any of Embodiments 1 to 6.

From the above results, it was confirmed that the tensile moduli of M100, M200, and M300 were higher in Embodiments 1 to 6 than in Comparative Embodiment.

### [Measurement of Hardness]

A Shore A hardness (HA) of the rubbers each obtained by crosslinking the rubber compositions in Embodiments 1 to 6 and Comparative Example was measured. The hardness (HA) was measured using a “rubber and plastic hardness meter (product number: GS-701N)” which is a product name and manufactured by Techclock Corporation.

The hardness (HA) in Embodiments 1 to 6 and Comparative Embodiment is shown in Table 2.

As shown in Table 2, the hardness (HA) in Embodiment 1 was 61.0. The hardness (HA) in Embodiment 2 was 64.0. The hardness (HA) in Embodiment 3 was 66.0. The hardness (HA) in Embodiment 4 was 68.0. The hardness (HA) in Embodiment 5 was 67.0. The hardness (HA) in Embodiment 6 was 67.0. The hardness (HA) in Comparative Embodiment was 65.0.

From the above results, it was confirmed that Embodiments 1 to 6 had a high hardness (HA) at the same level as Comparative Embodiment.

### [Evaluation of Riding Comfort and Steering Stability]

Four drivers drove vehicles equipped with suspension bushings to which the rubber compositions in Embodiments 2 to 4 and Comparative Embodiment were applied, respectively, and evaluated riding comfort and steering stability. The evaluation of the riding comfort and steering stability is shown in Table 3 below.

TABLE 3

| | | | Comparative | | | |
|---|---|---|---|---|---|---|
| Item | Test condition | | Embodiment | Embodiment 2 | Embodiment 3 | Embodiment 4 |
| Mooney viscosity ML(1 + 4)100° C. | — | | — | 53.0 | 66.0 | 78.0 |
| Steering responsiveness | 40 km/h | ±2° | 2.8 | 3.8 | 4.0 | 3.6 |
| | | ±30° | 2.8 | 3.8 | 4.2 | 3.6 |
| Steering response | 100 km/h | ±2° | 2.8 | 3.8 | 4.0 | 3.6 |
| | | ±30° | 2.8 | 3.8 | 4.2 | 3.6 |

| | | | | | |
|---|---|---|---|---|---|
| Riding comfort | Handling road | 3.5 | 4.0 | 4.2 | 3.6 |
| Handling | Normal traveling 60 | 3.0 | 3.8 | 4.2 | 3.6 |
| | km/h or less | | | | |
| Stability and security feeling | Tuck-in (under bank) | 3.5 | 3.8 | 4.0 | 3.6 |
| Trackability (Rr grip) | rapid steering ± 30° | 3.5 | 3.8 | 4.0 | 3.6 |
| | G test course 80 km/h | | | | |
| | SKC 120 km/h | | | | |
| Roll feeling | 100 km/h ± 30° | 3.0 | 3.7 | 4.0 | 3.6 |
| Roll resonance (roll back) | Slow to rapid steering | 2.8 | 3.7 | 4.0 | 3.6 |
| General riding comfort | 40 km/h | 3.5 | 4.0 | 4.2 | 3.6 |
| | Ramp and others | | | | |

| | | | | |
|---|---|---|---|---|
| Comprehensive evaluation | 3.0 | 3.7 | 4.2 | 3.6 |

In Table 3 above, steering responsiveness indicates responsiveness when steering is turned ±2° and ±30° while traveling at 40 [km/h]. Steering response indicates responsiveness when steering is turned ±2° and ±30° while traveling at 100 [km/h]. Riding comfort and handling indicate evaluation of handling and riding comfort during normal traveling (traveling at 60 [km/h] or less). Stability, security feeling, and trackability indicate vehicle stability and lack of delay when steering is turned ±30° while traveling around a curve at 120 [km/h]. Roll feeling and roll resonance indicate roll feeling and roll convergence when steering is turned ±30° at 100 [km/h]. General riding comfort indicates riding comfort when going over a small ramp of about 5 [mm] to 10 [mm] and going over a manhole at 40 [km/h].

In the item in Table 3, in terms of the steering stability indicated by the steering responsiveness, the steering response, the handling, the stability, the security feeling, the trackability, the roll feeling, and the roll resonance, Embodiment 3 was rated the highest, followed by Embodiment 2, Embodiment 4, and Comparative Embodiment was rated the lowest.

In the item in Table 3, in terms of the vehicle riding comfort indicated by the riding comfort and the general riding comfort, Embodiment 3 was rated the highest, followed by Embodiment 2, Embodiment 4, and Comparative Embodiment was rated the lowest.

From the above results, it was confirmed that Embodiments 2 to 4 had steering stability and riding comfort higher than Comparative Embodiment. It was confirmed that the steering stability and riding comfort were improved in the order of Embodiment 4, Embodiment 2, and Embodiment 3.

Although the preferred embodiments of the present disclosure have been described above with reference to the accompanying drawings, it goes without saying that the present disclosure is not limited to the embodiments. It is apparent to those skilled in the art that various modifications and alterations can be conceived within the scope of the claims, and it is understood that the modifications and alterations naturally fall within the technical scope of the present disclosure.

According to the present disclosure, both improved riding comfort and improved steering stability can be achieved by improving a tensile modulus.

1. A rubber composition comprising:
a millable urethane polymer;
an organic peroxide crosslinking agent; and
carbon having a nitrogen surface area of 30 m²/g or more and 100 m²/g or less,
wherein the millable urethane polymer has a Mooney viscosity ML(1+4)100° C. of 29 or more and 90 or less,
a content ratio of the organic peroxide crosslinking agent is 2 parts by mass or more and 4 parts by mass or less with respect to 100 parts by mass of the millable urethane polymer, and
a content ratio of the carbon is 1 part by mass or more and 40 parts by mass or less with respect to 100 parts by mass of the millable urethane polymer.

2. The rubber composition according to claim 1, wherein the millable urethane polymer has a Mooney viscosity ML(1+4)100° C. of 53 or more and 78 or less.

3. The rubber composition according to claim 1, wherein the carbon comprises first carbon and second carbon, the nitrogen surface area of the second carbon being different from that of the first carbon.

4. The rubber composition according to claim 2, wherein the carbon comprises first carbon and second carbon, the nitrogen surface area of the second carbon being different from that of the first carbon.

5. The rubber composition according to claim 3, wherein the nitrogen surface area of the first carbon is 30 m²/g or more and 50 m²/g or less, and the nitrogen surface area of the second carbon is 70 m²/g or more and 90 m²/g or less.

6. The rubber composition according to claim 4, wherein the nitrogen surface area of the first carbon is 30 m²/g or more and 50 m²/g or less, and the nitrogen surface area of the second carbon is 70 m²/g or more and 90 m²/g or less.

7. A vibration-proof rubber comprising a rubber obtained by crosslinking a rubber composition, the rubber composition comprising:
a millable urethane polymer;
an organic peroxide crosslinking agent; and
carbon having a nitrogen surface area of 30 m²/g or more and 100 m²/g or less,
wherein the millable urethane polymer has a Mooney viscosity ML(1+4)100° C. of 29 or more and 90 or less,
a content ratio of the organic peroxide crosslinking agent is 2 parts by mass or more and 4 parts by mass or less with respect to 100 parts by mass of the millable urethane polymer, and
a content ratio of the carbon is 1 part by mass or more and 40 parts by mass or less with respect to 100 parts by mass of the millable urethane polymer.
